(19) United States
(12) Patent Application Publication
(10) Pub. No.: US 2025/0376273 A1
(43) Pub. Date: Dec. 11, 2025

(54) System and Method for Reconfigurable Thermal Control in Spacecraft

(71) Applicants: Warren Wei-Szu Su, Marina del Rey, CA (US); Brian Minh Phan, Marina del Rey, CA (US)

(72) Inventors: Warren Wei-Szu Su, Los Angeles, CA (US); Brian Minh Phan, Los Angles, CA (US); Dustin Edward Holta, Los Angeles, CA (US)

(21) Appl. No.: 19/224,864

(22) Filed: Jun. 1, 2025

Related U.S. Application Data
(60) Provisional application No. 63/658,577, filed on Jun. 11, 2024.

(51) Int. Cl. B64G 1/50; B64G 1/22

(52) U.S. Cl. CPC B64G 1/503; B64G 1/226

(57) ABSTRACT

A spacecraft thermal control system is disclosed that includes a software reconfigurable radiator assembly capable of dynamically switching between high and low absorptance states to regulate thermal load. The system comprises a reflective display layer, such as an electrophoretic material, integrated into a multilayer radiator structure. A controller modulates the thermos-optical properties of the radiator based on pre-programmed or real-time inputs. The system allows for pre-integration into a satellite platform prior to receipt of mission-specific parameters and supports in-orbit thermal reconfiguration. The system can adapt to match changing orbits and mission environments, enabling flexible and responsive thermal management across different phases of operation. Additional features may include heat storage elements and thermal switches to manage payload-specific thermal requirements.

### CROSS-REFERENCE TO RELATED APPLICATIONS

This application claims the benefit of U.S. Provisional Patent Application No. 63/658,577, filed on Jun. 11, 2024, which is hereby incorporated by reference in its entirety.

### FIELD OF THE INVENTION

The present invention relates generally to thermal control systems and, more particularly, to thermal control systems for spacecraft.

### BACKGROUND OF THE INVENTION

Satellites are subjected to varying solar loads and component operational modes in space. They experience low temperature extremes when in low power scenario and eclipse, and high temperature extremes when in high power scenario and full solar load. The thermal control system of a spacecraft must account for such variations.

Traditionally, spacecraft thermal control systems have been designed on a mission-by-mission basis. Such systems have often relied on static materials with fixed properties. With existing thermal control technologies, the development of a satellite's thermal control system cannot begin until the details of a customer's payload and mission details have been announced. The definition of radiators, such as its size, area, surface finishes, and position on the spacecraft, are not allowed to begin until necessary payload and mission inputs have been gathered and finalized. After receiving the payload, the next steps involve procuring and building the necessary thermal hardware, a process that typically takes between three to six months. The disclosed invention eliminates this 3-6 months of incompressible schedule, streamlining the overall development cycle and workflow.

In the conventional approach, the performance of the radiator is fixed after they have been defined and fabricated. After this stage, the only way that the engineers would be able to adjust the radiator performance, other than resizing and fabricating a new radiator, is by physically covering areas of the radiator with multi-layer insulation. As such, adapting such a thermal system to varying mission requirements or operational environments is impractical. This limitation can result in increased development time and reduced flexibility in mission design and integration phase, as well as inefficient thermal management in on-orbit operation. Satellite manufacturers must redesign a different thermal control system for each new mission.

More recently, thermochromic materials have been used for thermal systems of spacecraft. Such materials are designed in such a way that they passively transition between high and low emissivity states at a specific, predetermined temperature threshold. However, they require developing a new formula in the lab to customize its properties for each new customer and mission. As such, it requires much effort and expense to adapt such material for each mission. Also, it cannot adapt itself for new requirements once integrated for launch and on orbit.

It should, therefore, be appreciated that there remains a need for a thermal control systems that address these needs and others.

### SUMMARY OF THE INVENTION

Briefly, and in general terms, the invention provides a thermal control system, usable on spacecraft, that enables dynamic or preconfigured adaptation of the thermal load on the system to accommodate varying system and mission parameters.

More specifically, in an exemplary embodiment, a thermal control system is provided that includes a radiator assembly that can controllably transition between different absorptance states by varying its absorptance-to-emittance (α/ε) ratio via software. The radiator assembly thermally communicates other satellite subsystems, to maintain those subsystems within prescribed temperature ranges. The thermal control system includes a controller that can transition the radiator assembly between its absorptance states in a prescribed manner, such as, e.g., with preconfigured software or by manual software commands executed on orbit.

In a detailed aspect of an exemplary embodiment, the radiator assembly includes a reflective display layer that can controllably change from a light (low α/ε) state to a dark (high α/ε) state, providing a dynamic modulation range, instant switching, and significant controllability, both autonomously and manually.

In another detailed aspect of an exemplary embodiment, the radiator assembly includes a reflective display layer that possesses highly contrasting solar absorptance states. The thermal control system also includes a controller that can configure the reflective display layer to a range of solar absorptance values within its two extreme states by software commands. The methods to rapidly configure and integrate a satellite thermal control system involves sizing and fabricating a radiator and attaching the radiator in advance. The methods allow pre-integration of a physical predefined radiator onto a standard satellite bus before receiving payload and mission parameters, such as payload size, power, mission orbit, and beta angle. Once the payload and mission parameters are confirmed, the process involves the use of the controller to define the solar absorptance properties of the pre-integrated radiator via software commands.

In a detailed aspect of an exemplary embodiment, the reflective display layer is selected from a group including electrochromic, electrophoretic, reflective liquid crystal displays (Reflective LCD), electrowetting, electrofluidic, interferometric modular display (IMODs), and digital micromirror devices (DMDs). In an exemplary embodiment, an electrophoretic layer is used.

Beneficially, in another detailed aspect of an exemplary embodiment, the software-definability enables rapid spacecraft thermal design process flow by enabling the definition of radiator sizes to take place while the following list of parameters are still unknown: payload dissipation, payload temperature limits, payload orientation, payload physical dimension, payload coating, mission orbit (altitude, inclination, etc.).

For purposes of summarizing the invention and the advantages achieved over the prior art, certain advantages of the invention have been described herein. Of course, it is to be understood that not necessarily all such advantages can be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIGS. 1A and 2B are simplified perspective views of a spacecraft having an active thermal control system in accordance with the present invention, depicting satellite bus having a controllable radiator assembly incorporated on outer surfaces of the spacecraft. FIG. 1A depicts the radiator assembly configured with a low absorptance-to-emittance (α/ε) ratio and FIG. 1A depicts the radiator assembly with a high absorptance-to-emittance (α/ε) ratio.

FIG. 2 is a simplified block diagram of the spacecraft of FIG. 1, depicting the thermal control system including a controller and the radiator assembly.

FIG. 3 is a simplified cross-sectional diagram of the controllable radiator assembly of the thermal control material for the spacecraft of FIG. 1, depicting the radiator assembly having several layer of materials including a reflective display layer formed of electrophoretic material that can be adjusted by the controller of the thermal control system.

FIG. 4 is a simplified block diagram for a method of designing an active thermal control system in accordance with the present invention.

FIG. 5 is a simplified block diagram for a method of programming the controller for an active thermal control system in accordance with the present invention.

### DETAILED DESCRIPTION OF THE PREFERRED EMBODIMENTS

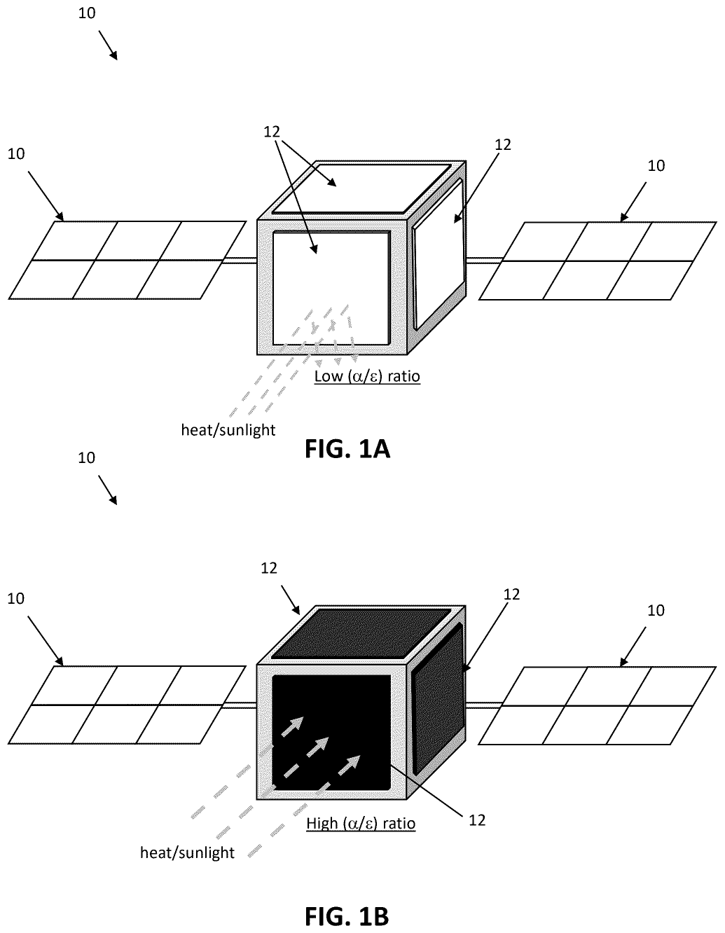

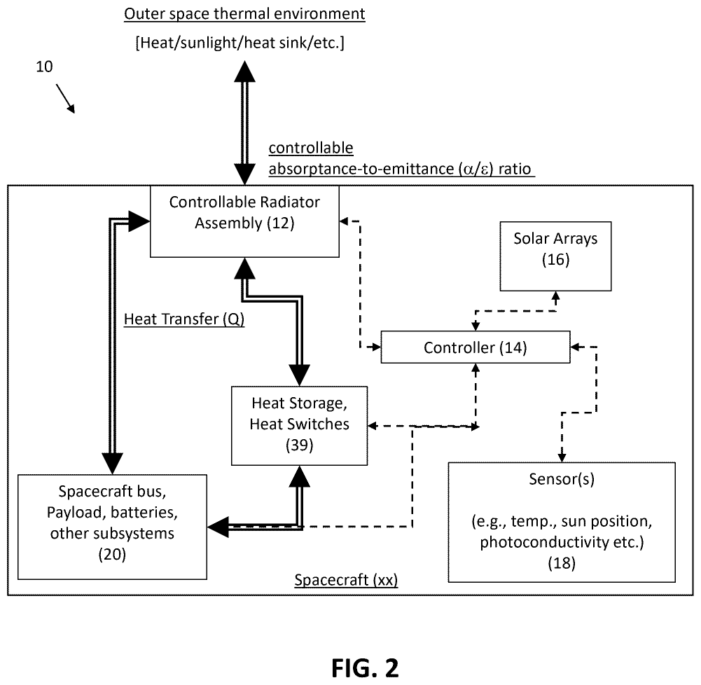

Referring now to the drawings, and particularly FIGS. 1 and 2, there is shown a spacecraft 10 having a thermal control system, enabling dynamic adaptation of the thermal load on the spacecraft to accommodate varying system and mission parameters. The thermal control system includes radiator assembly 12 and a controller 14 (FIG. 2). The radiator assembly includes panels located on the outer surface of the spacecraft that can controllably change from a light (low α/ε) state (FIG. 1A) to a dark (high α/ε) state (FIG. 1B). The thermal control system includes a controller that can transition the radiator assembly between its absorptance states in a prescribed manner. In this manner, the thermal control system can dynamically adapt to the thermal load on the system to accommodate varying system and mission parameters, providing a dynamic modulation range, instant switching, and significant controllability, both autonomously and manually.

As shown in FIG. 1A, the radiator assembly 12 can be configured in a light (low α/ε) state, to reflect away solar heat. More particularly, in this state, the radiator assembly reflects away external thermal heat, e.g., from solar rays. As shown in FIG. 1B, the radiator assembly can be configured in a dark (high α/ε) state, to absorb external heat.

With reference now to FIG. 2, controller 14 is in communication with the solar arrays 16 and sensor 18 to aid in active control of the radiator assembly 12. More particularly, the controller processes temperature, solar intensity, and sun location inputs from on-board sensors and the solar arrays adjust α/ε state thereof to maintain thermal requirements, as discussed in further detail below. The radiator assembly 12 is thermally connected via conductive heat paths with subsystems 20 of the spacecraft, such as payload, spacecraft bus and other subsystems to control the thermal load thereof. Depending on sunlight conditions, the radiator assembly can be tuned to different temperatures to direct the direction and intensity of conductive heat flows from/to the radiator assembly.

In the exemplary embodiment, the thermal control system further includes a heat storage assembly 39 thermally connected via conductive heat paths with the radiator assembly 12, and subsystems 20 of the spacecraft, such as payload, spacecraft bus and other subsystems to control the thermal load thereof. The heat switches can also be used to enable the system to controllably and selectively transfer heat between the subsystems and the radiator assembly 12. The controller 14 communicates with the heat storage assembly 39, heat switches, radiator assembly 12, and subsystems 20 to direct the thermal load there among. In this manner, the system can precisely manage the thermal requirements of each of the subsystems in an independent manner, to improve the performance, health, and lifespan thereof.

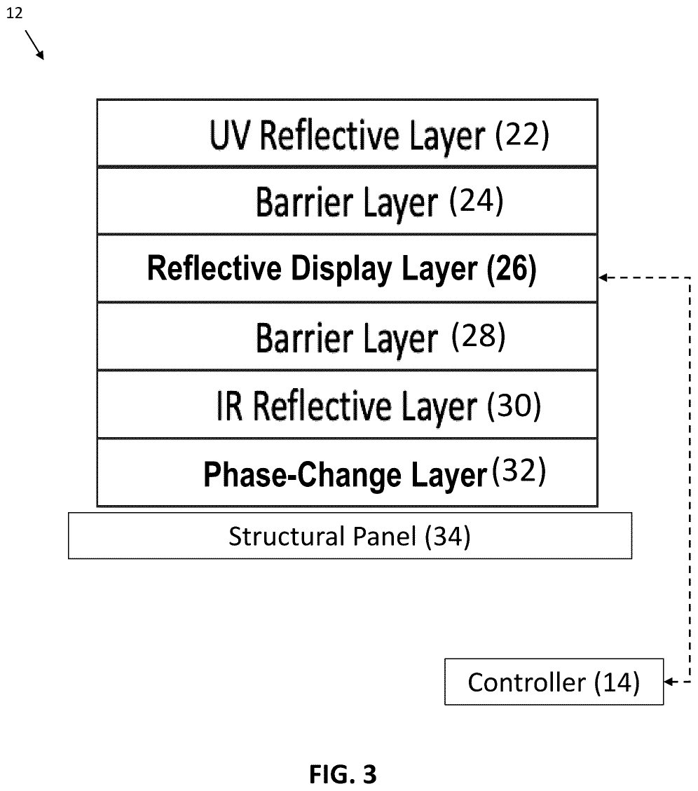

With reference now to FIG. 3, the radiator assembly 12 includes several layers, including a UV reflective layer 22, barrier layers 24, 28, a reflective display layer formed of electrophoretic 26, IR Reflective layer 30, and a phase-change layer 32. The controller 14 operates the reflective display layer to dynamically adjust the α/ε state thereof to control thermal requirements.

A structural panel 34 provides an interface for attaching the layers to the spacecraft bus. In the exemplary embodiment, the structural panel is sized and configured to attach to the spacecraft bus. The layers are adhered to the structural panel, and the structural panel is secured to the spacecraft bus.

The UV reflective layer 30 may consist of UV-resistant materials such as silicon dioxide (SiO₂)-coated, titanium dioxide (TiO₂)-coated, or indium tin oxide (ITO)-coated glass or polymer substrates. Glasses selected for this will make the radiator assembly more rigid and polymers would make it more flexible, as appropriate for selected embodiments. Glasses selected here can include any combination listed, such as, but not limited to, ceria-doped borosilicate, borosilicate, fused silica, quartz, aluminosilicate, aluminum oxide, calcium fluoride, among others. Polymers selected here can include any combination listed, such as, but not limited to, PET, FEP, PTFE, Polycarbonate, PVDF, among others.

The barrier layer 24 can be metal-oxide-polymers that can prevent outgassing of the electrophoretic layer and attenuation of proton and electron radiations with good transmission properties. Polymers selected here can include any combination listed, such as, but not limited to, fluorinated ethylene propylene film, fluorocarbon film, polycarbonate film, polyimide film, polyester film, among others.

In the exemplary embodiment, reflective display layer 26 is formed of electrophoretic material that can change its optical properties, such as, whenever an induced voltage is applied. Electrophoretic layers selected here can include any combination listed, such as, but not limited to, films provided by E Ink Corporation, among others.

In other embodiments, the reflective display layer 26 can be formed of other material that can be dynamically controlled by change from a light (low α/ε) state (FIG. 1A) to a dark (high α/ε) state. For example, the reflective display layer can be selected from a group including electrochromic, electrophoretic, reflective liquid crystal displays (Reflective LCD), electrowetting, electrofluidic, interferometric modular display (IMODs), and digital micromirror devices (DMDs).

The IR reflective layer 30 can be metal that has low IR absorption properties. Metals selected here can include any combination listed, such as, but not limited to, gold, silver, aluminum, among others.

A phase-change layer 32 can be used to provide a method for latent heat storage to enhance thermal control capabilities, in selected embodiments. Other embodiments can be excluded without departing from the invention. Materials selected here could include any combination listed, such as limited to, PET/Paraffin threads, among others. Each layer listed is bonded together with an optically clear adhesive that will be able to survive extreme space environments. The optically clear adhesives selected here can include any combination listed, such as, but not limited to, DOWSIL, 93-500 silicone, 3M acrylic, among others.

Besides the thermal control application described above, with highly hydrogenated materials such as polyethylene present, the assembly can potentially be used as a shielding material for galactic cosmic rays as a secondary capability. The electrophoretic layer can act as a phase-change latent heat system where high energy storage density (˜250 KJ/kg) can be leveraged to enhance its thermal control capabilities.

Another application for the present invention is to randomize the optical signatures of satellites. This proposed application would benefit stealth reconnaissance satellites as well as reduce light pollution on LEO constellations due to potential future regulations. Decreasing reflectance reduces reconnaissance satellites' visibility to adversaries' ground-based optical telescopes and reduces the light pollution from satellites and is an exemplary embodiment of other applications besides the thermal control system described above

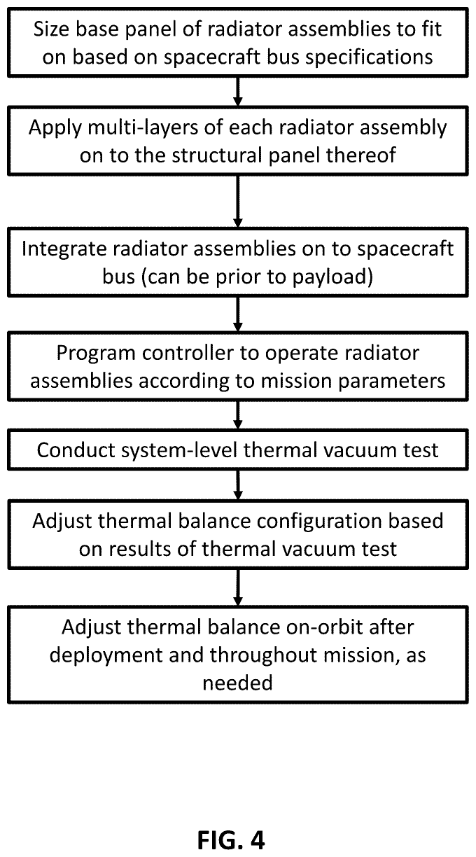

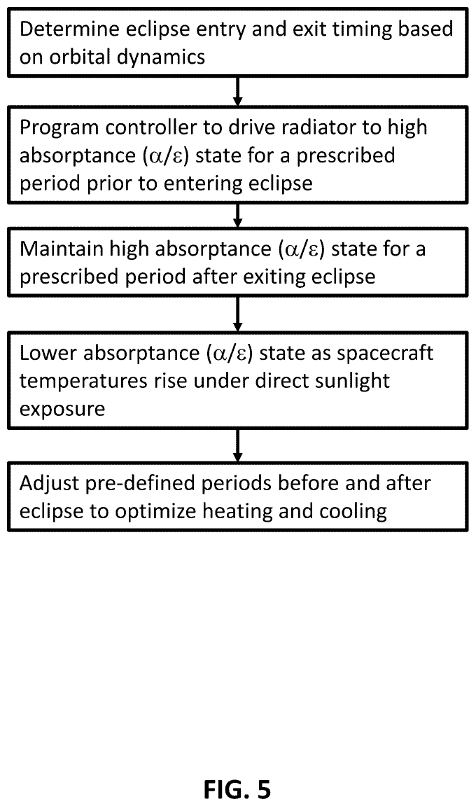

With reference now to FIG. 4, an exemplary method of producing a thermal control system for spacecraft 10 is shown. The structural panel 34 is sized to attach to the outer surface of the spacecraft. The multi-layers of the radiator assembly 12 are attached to the structural panel, forming the radiator assembly. The radiator assembly is then attached to the spacecraft. The radiator assembly 12 includes an electrophoretic layer 26. The controller 14 is programmed to adjust the α/ε state thereof to control thermal requirements. Controller 14 is programmed to assemblies according to mission parameters. Examples of such parameters are described with reference to FIG. 5. Thermal testing is conducted on the spacecraft, after which the thermal balance configuration based on results of vacuum test can be modified and updated in the controller. Also, while on orbit the controller can dynamically adjust operations of the radiator assembly, as needed

With reference now to FIG. 5, a method is shown for dynamically controlling the thermal environment of a spacecraft, to accommodate varying system and mission parameters. In the exemplary embodiment, controller 14 is programmed in consideration of the prescribed obit of the spacecraft. Prior to and while in an eclipse portion of an orbit, the controller maintains the radiators in a high absorptance (α/ε) state for a prescribed period prior to entering eclipse, to maintain the subsystems within a desired thermal range. After exiting the eclipse portion of the orbit, the controller adjusts the radiators in a low absorptance (α/ε) state, to maintain the subsystems within a desired thermal range and protect against overheating.

More specifically, in an exemplary embodiment, a thermal control system is provided that includes a radiator assembly that can controllably transition between different absorptance states by varying its absorptance-to-emittance (α/ε) ratio. The radiator thermally communicates with other satellite subsystems to maintain those subsystems with prescribed temperature ranges. The thermal control system includes a controller that can transition the radiator assembly between its absorptance states in a prescribed manner.

The present invention has been described above in terms of presently preferred embodiments so that an understanding of the present invention can be conveyed. However, there are other embodiments not specifically described herein for which the present invention is applicable. Therefore, the present invention should not be seen as limited to the forms shown, which is to be considered illustrative rather than restrictive.

Although the invention has been disclosed in detail with reference only to the exemplary embodiments, those skilled in the art will appreciate that various other embodiments can be provided without departing from the scope of the invention, to include any and all combination of features discussed herein.

Heat storage/switch is used to store excess heat energy when the spacecraft is exposed to sun and to release it when spacecraft is in eclipse, ensuring thermal stability and reducing thermal shocks. The controllable radiator assembly 12 is set to a dark (high α/ε) state to maximize heat absorption and storage for eclipse survival use. The heat storage/switch is positioned in between the controllable radiator assembly and the rest of the spacecraft 20. The heat storage/switch can be either completely passive or actively managed by the controller 14.

1. A thermal control system for a spacecraft, comprising:
a radiator assembly positionable on an outer surface of a spacecraft, configured to a controllably change from a light (low α/ε) state to a dark (high α/ε) state; and
a controller in communication with the radiator assembly, to dynamically adapt to the thermal load on the system to accommodate varying system and mission parameters, providing a dynamic modulation range, instant switching, and significant controllability.

2. The system of claim 1, wherein the radiator assembly includes a UV reflective layer, barrier layer, a reflective display layer, and IR reflective layer.

3. The system of claim 1, wherein the controller operates a reflective display layer of the radiator assembly to dynamically adjust the α/ε state thereof to control thermal requirements.

4. The system of claim 1, wherein the radiator assembly includes a reflective display layer formed of electrophoretic material that can change its optical properties in a controlled manner.

5. The system of claim 1, wherein the radiator assembly is thermally connected to subsystems of the spacecraft, such as payload, spacecraft bus and other subsystems to control the thermal load thereof.

6. The system of claim 1, further comprising a heat storage system assembly thermally connected to the radiator assembly.

7. The system of claim 6, further comprising a plurality of heat switches thermally connecting the heat storage assembly to the radiator assembly and subsystems of the spacecraft, to control the thermal load thereof.

8. The system of claim 1, wherein the reflective display layer is selected from the group consisting of electrochromic, electrophoretic, reflective LCD, electrowetting, electrofluidic, IMOD, and DMD materials.

9. The system of claim 1, wherein the thermal control system is software reconfigurable for pre-launch and on-orbit adaptation.

10. A method of thermally regulating a spacecraft, comprising:
pre-integrating a radiator assembly with a spacecraft bus; and using a software controller to configure the radiator assembly to a desired absorptance state based on mission-specific parameters received after integration.

11. The method of claim 10, further comprising conducting thermal testing and reprogramming the controller based on thermal balance results.

12. The method of claim 10, wherein configuring includes setting the α/ε state to match orbital parameters and payload thermal requirements.

13. The method of claim 10, wherein the radiator assembly includes an electrophoretic display layer controlled via voltage input.

14. The method of claim 10, wherein the radiator's thermos-optical state is adjusted dynamically in response to sun exposure and eclipse entry or exit.

15. A spacecraft comprising:
a structural panel mounted with a multi-layer radiator assembly including a reflective display layer; a controller configured to operate the reflective display layer to adjust thermal properties; and heat storage components thermally coupled to the radiator assembly and spacecraft subsystems.

16. The spacecraft of claim 15, wherein the multi-layer radiator assembly includes a UV protective layer and IR reflective layer.

17. The spacecraft of claim 15, wherein the reflective display layer is dynamically adjustable via a programmable controller.

18. The spacecraft of claim 15, further comprising heat switches managed by the controller to redistribute thermal energy between components.

19. The spacecraft of claim 15, wherein the controller adjusts the radiator's state to a high absorptance condition prior to eclipse for heat storage.

20. The spacecraft of claim 15, wherein the radiator also serves as an optical stealth feature to reduce satellite visibility.
